(19) United States
(12) Patent Application Publication
(10) Pub. No.: US 2012/0058323 A1
(43) Pub. Date: Mar. 8, 2012

(54) Control of Strain Through Thickness in Epitaxial Films Via Vertical Nanocomposite Heteroepitaxy

(75) Inventors: Judith L. Driscoll, Cambridge (GB); Quanxi Jia, Los Alamos, NM (US); Patrick Zerrer, Weinstadt (DE)

(73) Assignee: LOS ALAMOS NATIONAL SECURITY, LLC, Los Alamos, NM (US)

(21) Appl. No.: 12/671,891

(22) PCT Filed: Aug. 1, 2008
(86) PCT No.: PCT/US08/09337

§ 371 Date: Nov. 15, 2011

Related U.S. Application Data
(60) Provisional application No. 60/963,255, filed on Aug. 2, 2007.

(51) Int. Cl. B32B 15/00

(52) U.S. Cl. 428/220

(57) ABSTRACT

A two-dimensional vertical heteroepitaxial strain controlled composite is grown. The strain-controlling phase can be benign in all other respects so that the functional properties of the parent phase are unchanged, improved/enhanced, and/or manipulated. The new composite is advantageous because there is no need for expensive specialized crystals and because there are no thickness limitations.

### STATEMENT OF FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

This application claims the benefit of U.S. Provisional Patent Application Ser. No. 60/963,255, filed Aug. 2, 2007 and PCT/US2008/009337 filed Aug. 1, 2008, incorporated by reference herein.

### FIELD OF INVENTION

The present invention relates to a technique to control strain in films.

### BACKGROUND

Films form the basis of a wide range of applications in device materials technologies including semiconductor electronics, optoelectronics, memories, sensors, capacitors, and detectors. In most cases, a film is formed by growing one or several layers onto a substrate. When a film has the same crystalline orientation as that of the substrate onto which the film is grown, the film is referred to as an “epitaxial layer” and the process of growing the film on the substrate is referred to as “epitaxial film” growth. Epitaxial film can be either homoepitaxy (film material is same as substrate material) or heteroepitaxy (film material is different from substrate material).

A problem that has been recognized in connection with lattice-mismatched heteroepitaxy has been that the mismatch stress present at the substrate/film interface remains constant throughout the film as growth proceeds and consequently the strain energy grows with film thickness. At a critical layer thickness (“t_{C}”), normally on the order of a few nanometers, dislocations are created in the epilayer as the integrated strain energy becomes larger than the energy required to nucleate a defect. This has limited defect-free, heterogeneous film growth to very thin layers below the critical thickness at which dislocation occurs. Thus, strain engineering through the substrate is inadequate because many functional applications require thicker films (i.e., films exceeding 200 nanometers (“nm”)).

Work reported in 2005 by Lee et al in “Nature” (Strong polarization enhancement in asymmetric three-component ferroelectric superlattices, Nature 433, 395-399 (2005)) suggested that strain control through horizontal multilayering could circumvent the thickness limitation. Although the horizontal multilayer approach to strain control has proven successful for some applications, the complexities of the approach are technologically limiting.

Thus, a film nanocomposite system that maintains strain control in films of thickness well above t_{C} and is not technologically limiting is currently unavailable.

### SUMMARY OF THE INVENTION

This invention satisfies the current void and enables the user to grow a film nanocomposite system that maintains strain control in films of thickness well above the t_{C}. More specifically, the invention relates to a vertically strain-controlled nanocomposite (“VSCN”) system.

By way of example, and not of limitation, the present invention is a two-dimensional vertical heteroepitaxial strain controlled composite that is at least 10 nanometers thick. In one aspect of the present invention, the composite is characterized as having a checkerboard surface. The composite comprises (1) a substrate and (2) a self-assembled layer comprising a material X and a material Y thereon. Material X and material Y are immiscible metal containing materials. The materials can have a difference in room temperature elastic moduli perpendicular to the substrate of at least 50 giganewtons per square meter. Moreover, the molar ratio of material X to material Y generally ranges from about 2:3 to about 3:2.

In another aspect of the present invention, the two-dimensional vertical heteroepitaxial strain controlled composite is at least 10 nanometers thick and is characterized as having an interspersed columnar structure. The composite comprises (1) a substrate and (2) a layer comprising a material X and a material Y thereon. Material X and material Y are immiscible metal containing materials. The materials can have a difference in room temperature elastic moduli perpendicular to the substrate of at least 50 giganewtons per square meter. Moreover, the molar ratio of material X to material Y ranges from 1:6 to about 6:1, more usually from about 2:3 to about 3:2, with the proviso that material X and material Y are not (i) barium titanate and cobalt ferrite, or (ii) bismuth ferrite and cobalt ferrite.

In yet another aspect of the present invention, the two-dimensional vertical heteroepitaxial strain controlled composite is at least 10 nanometers thick and is characterized as having an interspersed columnar structure. The composite comprises (1) a substrate and (2) a layer comprising a material X and a material Y thereon. Material X and material Y are immiscible metal containing materials. The materials can have a difference in room temperature elastic moduli perpendicular to the substrate of at least 50 giganewtons per square meter. Moreover, the molar ratio of material X to material Y ranges from about 1:6 to about 6:1, more usually from about 2:3 to about 3:2. In addition, material X and material Y are independently selected from pervoskite type materials, rare earth oxide type materials, hexagonal structured metal oxide type materials, fluorite structured metal oxide type materials, rock salt structured metal oxide type materials, pyrochlore structured metal oxide type materials, spinel structured metal oxide type materials, single metal element, and binary non-oxide compounds.

### BRIEF DESCRIPTION OF THE DRAWINGS

FIG. 1 shows generic diagrams of VSCN systems formed from two mismatched phases. For simplicity, the two phases are shown to be strained equally, but in different strain states (compression or tension).

FIG. 2 shows cross section transmission electron microscopy (“TEM”) micrographs of lanthanum strontium manganese oxide (La_{0.7}Sr_{0.3}MnO₃) (“LSMO”)/zinc oxide (“ZnO”) on strontium titanate (“STO”). FIG. 2A is low magnification. FIG. 2B shows high resolution TEM (“HRTEM”) images along LSMO and ZnO column boundary. FIG. 2C shows Fast Fourier transform (“FFT”) filtered images of FIG. 2B.

FIG. 3 shows high-resolution x-ray diffraction (“HRXRD”) measurements of out-of-plane lattice constants for ZnO and LSMO in pure and nanocomposite films on STO. Bulk values are also shown.

FIG. 4 shows bismuth ferrite (BiFeO₃)(“BFO”)/samarium (III) oxide (Sm₂O₃) (“SmO”) films on STO. FIG. 4A shows a cross section low magnification TEM and corresponding selected area diffraction. FIG. 4B shows HRTEM along the interface of BFO and SmO. FIG. 4C shows the corresponding FFT image.

FIG. 5 shows HRXRD measurements of out-of-plane lattice constants for SmO and BFO in pure and nanocomposite films on STO. Bulk values are also shown.

FIG. 6 shows leakage current density as a function of dc bias field of pure BFO and nanocomposite BFO/SmO films on Niobium (“Nb”)-doped STO substrates that also serve as a conductive electrode.

FIG. 7 shows dielectric loss as a function of frequency of pure BFO and nanocomposite BFO/SmO films on Nb-doped STO substrates that also serve as a conductive electrode.

FIG. 8 shows out-of-plane lattice parameters versus out-of-plane strain, relative to bulk lattice parameter, in BFO/SmO nanocomposite films compared to the pure films and to the bulk. Inset shows planar TEM image of spontaneously ordered microstructure including a checkerboard structure.

FIG. 9 shows x-ray diffraction (“XRD”) θ-2θ scan of a nanocomposite BFO/neodymium (III) oxide (“NdO”) film on STO substrate. Both BFO and NdO are (001) oriented.

FIG. 10 shows XRD φ-scans of STO (101) and NdO (404) of a BFO/NdO nanocomposite film on STO substrate.

FIG. 11 shows the XRD φ-scans of STO (110) and BZO (110) of a YBCO/BZO nanocomposite film on STO substrate.

FIG. 12 shows the shift in BTO peaks by incorporation of Y₂O₃, SmO, and NdO.

FIG. 13 shows a computer representative of an AFM image of a two-phase BFO (background) and FeₓO grains (triangles).

FIG. 14 shows the ferromagnetic properties obtained for the two-phase BFO and FeₓO system.

FIG. 15 shows an XRD plot of a BaTiO₃/TiO₂ film in accordance with the present invention.

FIG. 16 shows a computer representative of an AFM image of Sm₂O₃ oval clusters in a background of BaTiO₃ in accordance with the present invention.

FIG. 17 shows a comparison plot of dielectric properties for a pure reference material of BaTiO₃ in comparison to two differing composites of BaTiO₃/Sm₂O₃ in accordance with the present invention.

FIG. 18 shows a TEM cross-section photomicrograph image of the nanocomposite structure of BaTiO₃/Sm₂O₃ in accordance with the present invention.

FIG. 19 shows plots of levels of strain as a function of growth temperature for of BaTiO₃/Sm₂O₃ in accordance with the present invention.

FIG. 20 shows an XRD plot of BaTiO₃ with secondary phases of ZrO₂ or Y₂O₃ accordance with the present invention.

### DETAILED DESCRIPTION

One aspect of the present invention relates to a new and useful film nanocomposite system that maintains strain control in films of thickness well above t_{C}. More specifically, the invention relates to a VSCN system comprising a substrate and a number of materials thereon. This invention holds considerable promise for strain engineering of thick films where at present it is only possible in sub-100 nm films. The advantages are: (1) strain can be controlled in films thicker than t_{C} and (2) there is no need for complex horizontal multilayering because vertical multilayering occurs naturally.

The substrate of the VSCN system can be formed from any single crystal material.

The number of materials upon the substrate is not set. In one embodiment of the invention the VSCN system is a binary system in which the two materials have the potential to form clean, heteroepitaxial nanocomposite films; however, the VSCN system can extend to a tertiary (or even greater) system to accomplish the desired functionality.

The VSCN system can include materials independently selected from perovskite, rare earth oxide, hexagonal structured metal oxides, fluorite structured metal oxides, rock salt structured metal oxides, pyrochlore structured metal oxides, spinel structured metal oxides, a single element, and binary non-oxide compounds.

A perovskite is a material with crystals that take the same structure. The basic chemical formula is ABO₃ wherein A and B are cations of different sizes. Examples of perovskite materials include, but are not limited to, BaTiO₃, BiFeO₃, PbTiO₃, ZrTiO₃, BaNbO₃, LaMnO₃, LaVO₃, YMnO₃, BaFeO_{3-X}, BaSnO₃, LaCrO₃, LaCoO₃, ScAlO₃, GdAlO₃, SmAlO₃, EuAlO₃, YAlO₃, CdTiO₃, CaTiO₃, CaTiO₃, CdSnO₃, CaGeO₃, LaAlO₃, SrTiO₃, CaRuO₃, SrRuO₃, DyScO₃, SrScO₃, YBa₂Cu₃O_{7-X}, and different mixtures of the above such as Ba_{1-X}Sr_{X}TiO₃, Pb₁₋ₓZrₓTiO₃, and Sr_{1-X}Ca_{X}RuO₃.

A rare earth oxide has the formula RE₂O₃ and may include either a single rare earth element or a mixture of rare earth elements. Rare earth elements include scandium, yttrium, lanthanum, cerium, praseodymium, neodymium, samarium, europium, gadolinium, terbium, dysprosium, holmium, erbium, thulium, ytterbium, and lutetium.

Examples of hexagonal structured metal oxides include, but are not limited to ZnO, Al₂O₃, BaFeO_{3-X}, BaFe₁₂O₉, YMnO₂, YbMnO₂, Ba₅Nb₄O₁₅, BaTa₂O₆, Y—Fe garnets, and mixtures of these. Examples of fluorite structured metal oxides include, but are not limited to, ZrO₂, (Y,Zr)O₂, HfO₂, SnO₂ or In-doped SnO₂, CeO₂, Bi₂O₃, and mixtures of these. Examples of rock salt structured metal oxides include, but are not limited to, MgO, NiO, and mixtures of these. Examples of pyrochlore structured metal oxides include, but are not limited to, Gd₂Zr₂O₇, La₂ZrO₇, Sm₂Zr₂O₇, and mixtures of these. Examples of spinel structured metal oxides include, but are not limited to, CoFe₂O₄, NiFe₂O₄, MnFe₂O₄, Gd₂NiO₄, La₂NiO₄, Sr₂RuO₄, Gd₂CuO₄, Eu₂CuO₄, Sm₂CuO₄, La₂CuO₄, Nd₂CuO₄, and mixtures of these. Examples of single elements include, but are not limited to, Si, Cu, Ge, and Ga. Examples of binary non-oxide compounds include, but are not limited to, GaN, TiN, AlN, BN, SiGe₂, and CuGe.

The materials chosen from the above examples to form clean, heteroepitaxial nanocomposite films should:
1. have the potential to grow epitaxially on a given substrate;
2. have approximately similar growth kinetics (i.e., the two phases should be able to grow at a similar system temperature);
3. have different ionic radii of the cations so that the materials only minimally mix; and
4. be thermodynamically stable when the individual materials are combined.

If the system is binary, then the two phases must be immiscible (to allow a clean nanocomposite mix). Further, if the system is binary and the elastic moduli of each phase perpendicular to the substrate is distinct, then the phase with the high elastic modulus acts more as the “strain controller” phase and the phase with the lower elastic modulus acts more as the “strain-controlled” phase.

Moreover, if the system is binary and a checkerboard surface is desired, then the molar ratio of material X to material Y should range from about 2:3 to about 3:2. However, where a more randomly ordered binary system is desired, then any molar ratio of material X to material Y may be used, although generally, the molar ratio will range from about 1:6 to about 6:1. Similarly, if a randomly ordered tertiary system is desired, then any molar ratio of material X to material Y to material Z may be used.

In a binary system, one material may be active and the other passive. An active material provides specific properties or functionalities that can be tuned or modified by lattice strains and stresses provided by the combination of materials. Conversely, a passive material does not provide specific properties or functionalities or is incapable of providing specific properties or functionalities by itself. For example, in a BFO/SmO binary system, the BFO is active and the SmO is passive. Alternatively, both phases may be active. For example in a BiMnO₃/ZnO binary system, both the BiMnO₃ (magnetic insulator and magnetostrictive) and ZnO (piezoelectric) are active. Moreover, when a voltage is applied to the BiMnO₃/ZnO system, the ZnO will change shape, which causes straining of the BiMnO₃ and alteration of its magnetic state.

By properly selecting the materials, vertical strain control can be achieved. The effectiveness of the vertical strain depends on the quality of the columnar interfaces and the area between them. Assuming perfect strain coupling at the interface, then a simple model can be used to estimate the transition thickness, t_{T}, for the switch-over from lateral (i.e., substrate) strain control to vertical strain control.

The following equations are used to calculate t_{T}:

Interfacial area of each nanocolumn A_{c}=(4at)/2=2at(counting each side wall twice)

Interfacial area with the substrate Aₛ=a×a

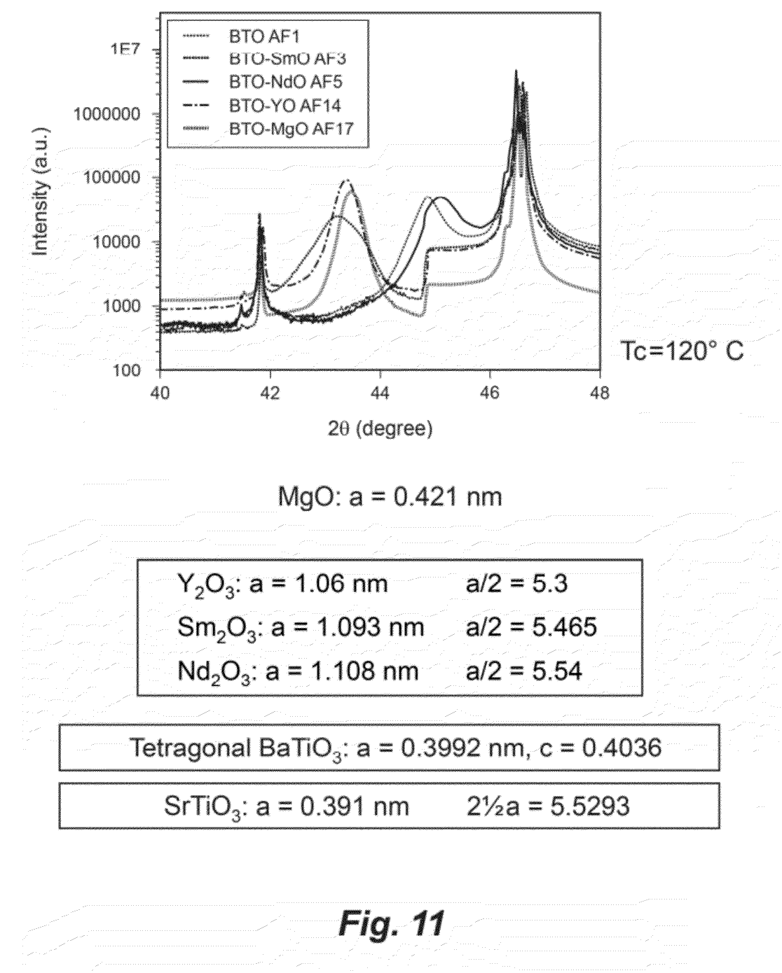

When A_{c}>Aₛ, vertical strain control dominates: 2at>a²→t_{T}>a/2 where a is the width of each column and t is the film thickness
Assuming the nanocolumns have a square cross-section with an average dimension of a, then for a=20 nm and films thicker than 10 nm, vertical 2-D strain control should dominate over lateral strain control (see FIG. 11).

Theoretically there is not a thickness limitation to the vertical strain control; however, in practice, an upper thickness limit of approximately about 1 micrometer (“μm”) may be expected because the interfaces will meander somewhat from a vertical plane as the film thickens.

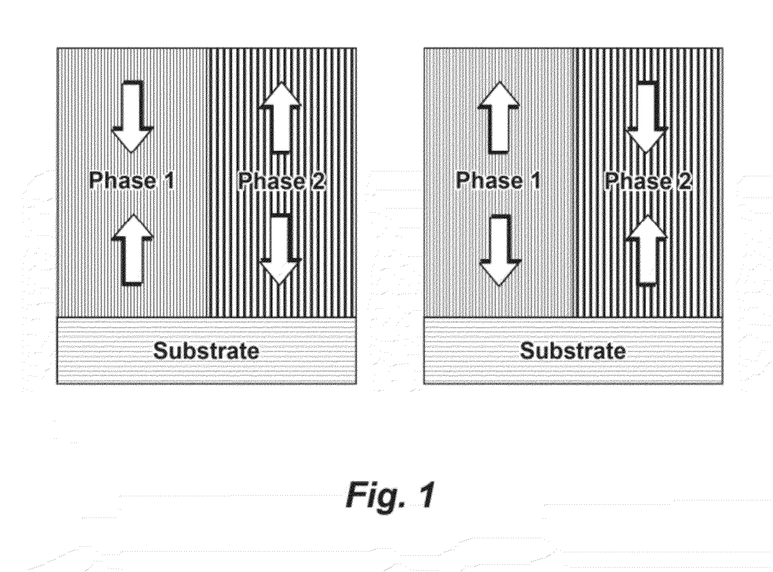

FIG. 1 demonstrates the vertical strain concept. For simplicity, FIG. 1 shows an ordered arrangement of phases. In a pure film, the phase is simply strained to the heteroepitaxial isostructural substrate. Arrow 1 shows the situation where the film is put into tension by the substrate. Arrow 2 shows the resulting out-of-plane compression in the film; however, in the presence of the second phase, arrow 3 shows that the vertical strain at the interface also needs to be taken into account.

Reference is now made in detail to various embodiments of the invention. A first embodiment is the growth of composite LSMO/ZnO nanocomposite films. Another embodiment is the growth of composite BFO/SmO nanocomposite films. Still another embodiment is the growth of composite BFO/NdO nanocomposite films. Yet another embodiment is the growth of composite YBCO/BZO nanocomposite films. Another embodiment is the growth of composite BTO/SmO nanocomposite films. Another embodiment is the growth of composite is BTO/NdO nanocomposite films.

Regarding the material selection, each system complied with the guidelines in [0039] through [0042].

Film growth was accomplished by creating ceramic-pulsed laser deposition (“PLD”) target compositions. To fabricate each target composition 99.9% pure starting materials of the oxides, carbonates, or nitrates were milled, pressed, and sintered.

Each embodiment was analyzed by HRXRD. A Philips PW3050/65 X′Pert PRO HR horizontal diffractometer was used for the HRXRD work. The standard setup used an asymmetric 4-bounce Ge (220) monochromator together with the 3-bounce Ge (220) analyzer crystal in front of the detector. An automatic nickel absorber decreased the beam intensity if the count rate exceeded 400.00 counts per second. The data collection software took account of the change in count rate. The gathered data was analyzed with X′Pert Epitaxy 4.0 (Philips). The sample was mounted with a double-sided tape on the sample holder. After mounting the sample holder the diffractometer position was checked. A scan through 2θ=0 was done and the maximum was set to zero. Then the beam was cut down to the size of the film and the sample holder was moved until the sample cut the beam and the beam intensity decreased by 50%, which adjusted the sample height. The procedure allowed the lattice parameters to be determined on an absolute basis. The same procedures were used for a symmetric scan. The out-of-plane lattice parameters were measured by refining the (00/) peak positions using the profile-fitting software Philips Profit 1.1c.

Each embodiment was analyzed by TEM. Both low magnification (in a JEOL2010 microscope) and high resolution cross-section and plain-view (in a JEOL3000F analytical electron microscope with point-to-point resolution of 0.17 nm) transmission electron microscopy were undertaken. Selected area diffraction patterns were also collected. FFT were performed on several areas of the cross-section images.

Physical properties and dielectric loss measurements of each embodiment were taken. Magnetization measurements were conducted in a SQUID both upon heating with an applied field of 200 Oersted (“Oe”) and in 2K temperature intervals. For transport property measurements, platinum electrodes with an area of 1×10⁻⁴ cm², defined by a standard lift-off lithograph process, were deposited by sputtering. The frequency dependent capacitance and dielectric loss of capacitors were measured using a HP4194A impedance analyzer.

### Example 1

### LSMO/ZnO VSCN Films

A composite (La_{0.7}Sr_{0.3}MnO₃)_{0.5}/(ZnO)_{0.5} target was prepared through standard target preparation procedures. The LSMO/ZnO nanocomposite films were deposited on SrTiO₃ and sapphire by pulsed laser deposition using a xenon chloride (“XeCl”) excimer laser (λ=308 nm). A substrate temperature of 750° C. and oxygen pressure of 200 milliTorr (“mTorr”) were used during the deposition. After the deposition, the films were cooled in an oxygen atmosphere of 200 Torr without any further in-situ thermal treatment.

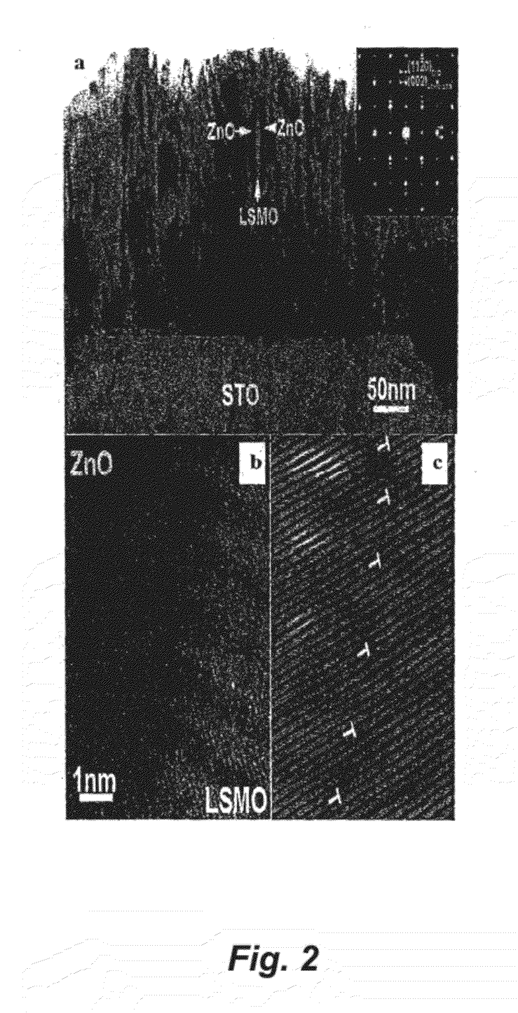

FIG. 2A shows a low magnification cross-sectional TEM image of an LSMO/ZnO films on STO. HRTEM images along the LSMO/ZnO column boundaries (FIG. 2B) showed a Moiré pattern that exactly corresponds to the misfit dislocation cores observed along the boundary shown in the FFT image (FIG. 2C).

The domain matching epitaxy (“DME”) relation of ZnO:LSMO was measured to be 6:5. The DME relation was understood from: ZnO (11 2̅0)//LSMO (001)//STO (001).

Calculated domain width for each phase:

d_{(11 2̅0)ZnO}=3.260 Å and 3.260×6=19.60 Å.

d_{(001)LSMO}=3.854 Å and 3.854×5=19.27 Å.

Measured domain width from TEM: 19.5 Å.

A comparison of the measured domain width with the calculated widths for ZnO and LSMO shows (in the out-of-plane direction) that the ZnO lattice was compressed and the LSMO was tensed. The Moiré pattern was only observed in LSMO domains which was consistent with the LSMO being strained the most.

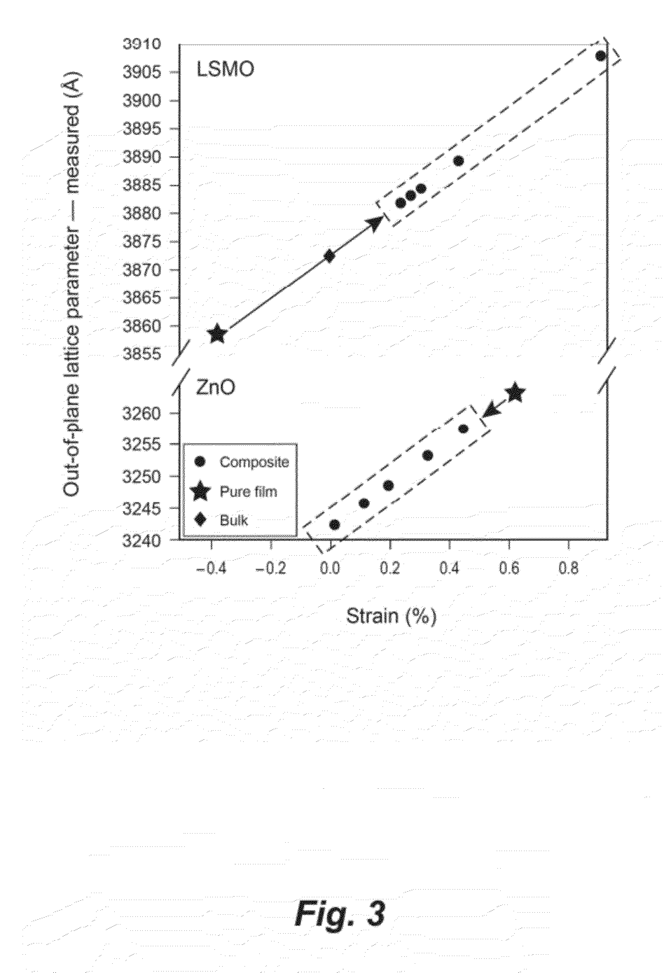

The HRXRD measurements were in direct agreement with the HRTEM. FIG. 3 shows the out-of-plane lattice parameters for a number of films of different thickness (200 nm-450 nm), as well as the calculated strain values. The pure film lattice parameters for ZnO/STO and LSMO/ZnO, and the bulk values for LSMO and ZnO are also included. It was observed that when pure LSMO films were grown on STO, in the out-of-plane direction the films were in compression (i.e., in tension in-plane because of the larger lattice parameter of STO (3.91 Å) compared to LSMO (3.854 Å)); however, when the films were intergrown with ZnO, the out-of-plane strain state switched to tensile.

Also shown was that appropriate annealing led to strain relaxation in the films. This allowed the films to be tuned to exhibit either a high resistivity and good low-field magnetoresistive response, or low resistivity (single crystal-like) and hence poor low-field magnetoresistive response. B. S. Kang et al., Appl. Phys. Lett., 88, 192514/3 (2006).

### Example 2

### BFO/SmO VSCN Films

A composite (BFO)_{0.5}/(SmO)_{0.5} target was prepared through standard target preparation procedures. The BFO/SmO nanocomposite films were deposited on SrTiO₃, Nb-doped SrTiO₃, and sapphire substrates by pulsed laser deposition using a XeCl excimer laser (λ=308 nm). A substrate temperature of 670° C. and oxygen pressure of 100 mTorr were used during the deposition. After the deposition, the films were cooled in an oxygen atmosphere of 200 Torr without any further in-situ thermal treatment.

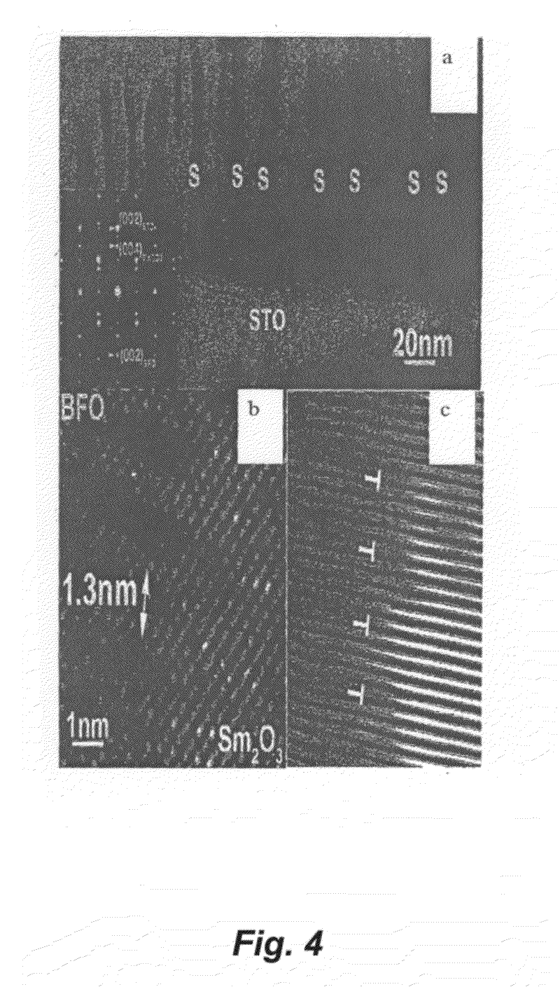

Similar to LSMO/ZnO, for the BFO/STO films on STO, DME was observed along the vertical interface between the phases. TEM (FIGS. 4A and 4B) and corresponding FFT images (FIG. 4C) revealed the matching relation to be BFO:SmO of 7:5.

The 7:5 matching relationship was understood from: BFO(001)//SmO (001)//STO(001).

Calculated domain width for each phase:

d_{(002)BFO}=1.98 Å and 1.98×7=13.86 Å

d_{(004)SmO}=2.73 Å and 2.73×5=13.65 Å

Measured domain width: 13.6 Å.

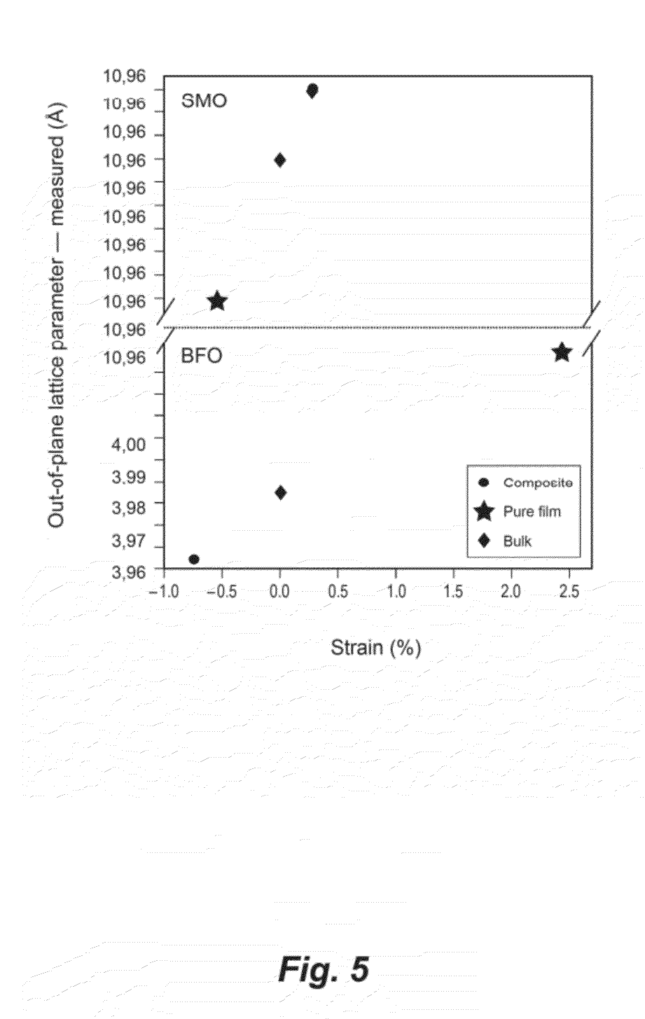

A comparison of the measured domain width with the calculated widths for BFO and SmO, showed (in the out-of-plane direction) that the BFO was in compression and the SmO was in a near-relaxed state. As in the LSMO/ZnO system, the Moiré pattern was observed in the highly strained BFO domains confirming that the strain was localized mainly in the BFO. The HRXRD results were again in direct agreement with the HRTEM results. In the out-of-plane direction, the strain state of the BFO switched from tensile to compressive through strain coupling with the SmO nanocolumns. FIG. 5 shows the out-of-plane lattice parameters for a 150 nm thick BFO/SmO nancomposite film, as well as the calculated strain values. This is the opposite of the LSMO/ZnO system where the ZnO causes the LSMO to be tensed. In both cases, however, the binary oxides strain the perovskites more than the perovskites strain the binary oxides. This was expected based on the respective elastic modulii.

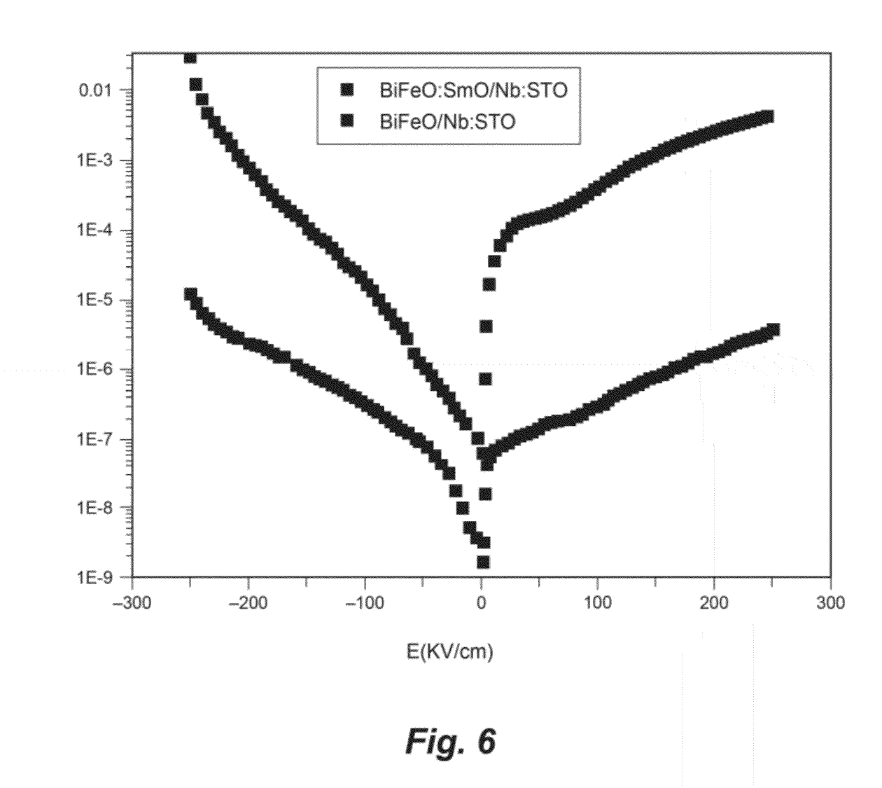

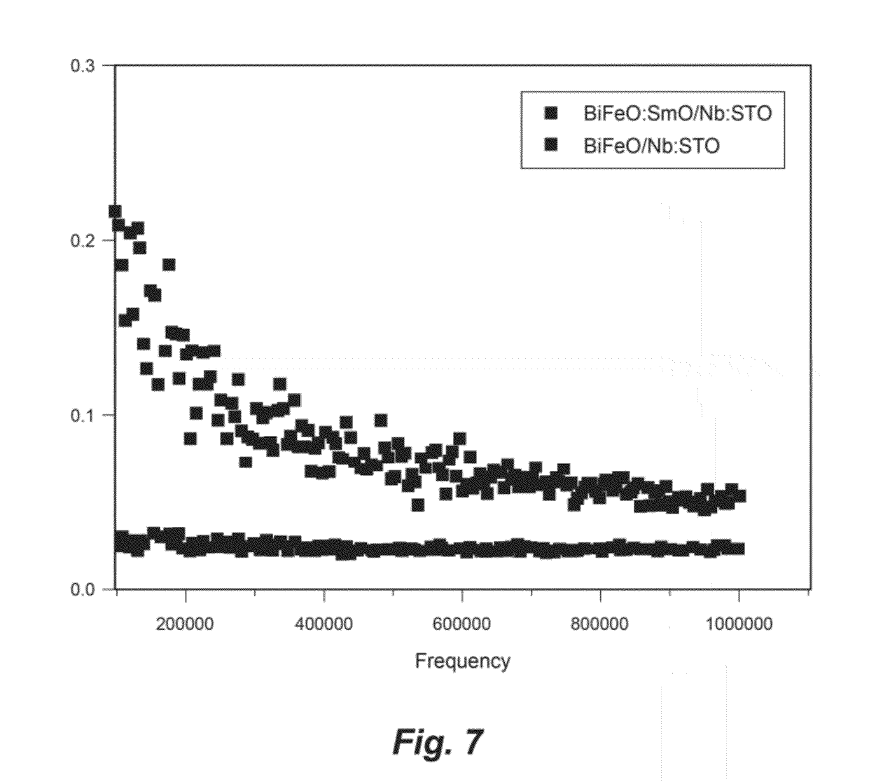

Importantly, the physical properties of the BFO also improved dramatically. For example, both the leakage current density and the dielectric loss of the nanocomposite were much smaller than the pure BFO films. FIGS. 6 and 7 show the leakage current density and the dielectric loss of pure BFO and nanocomposite BFO/SmO films, respectively.

### Example 3

### BFO/SmO VSCN Films

Pure BiFeO₃ and Sm₂O₃ films and additional nanocomposites (50 at. % BiFeO₃ and 50 at. % Sm₂O₃) films were grown utilizing pulsed laser deposition (Lambda Physik, KrF laser λ=248 nm) of ceramic targets. All the films are deposited on (001)-oriented STO substrates at T=680° C. under a flux of pure oxygen gas pO₂=100 mTorr. The thickness of the films was 15 nm to 150 nm. The films were investigated by XRD, HRXRD and TEM. The dielectric properties of the films were also investigated.

The orientation of the pure BiFeO₃ (BFO) films on STO was cube-on-cube and for pure Sm₂O₃ (SmO) 45° rotated cube-on-cube. The 45° rotation allowed lattice matching of 10.92/4×\sqrt{2}=3.86 Å in SmO with (3.905 Å) in STO. As shown in FIG. 1, for the pure BFO film, the vertical lattice parameter was 4.000 Å which is higher than the bulk value of 3.962 Å. Hence, the film is in tension out-of-plane and in compression in-plane, as predicted from the smaller STO lattice parameter (a=3.905 Å). The vertical lattice parameter in the composite was a=3.905 Å, which is lower than the pure film value of 4.000 Å. This means that vertical strain state in the BFO is switched from tension to compression by vertical strain control by the SmO.

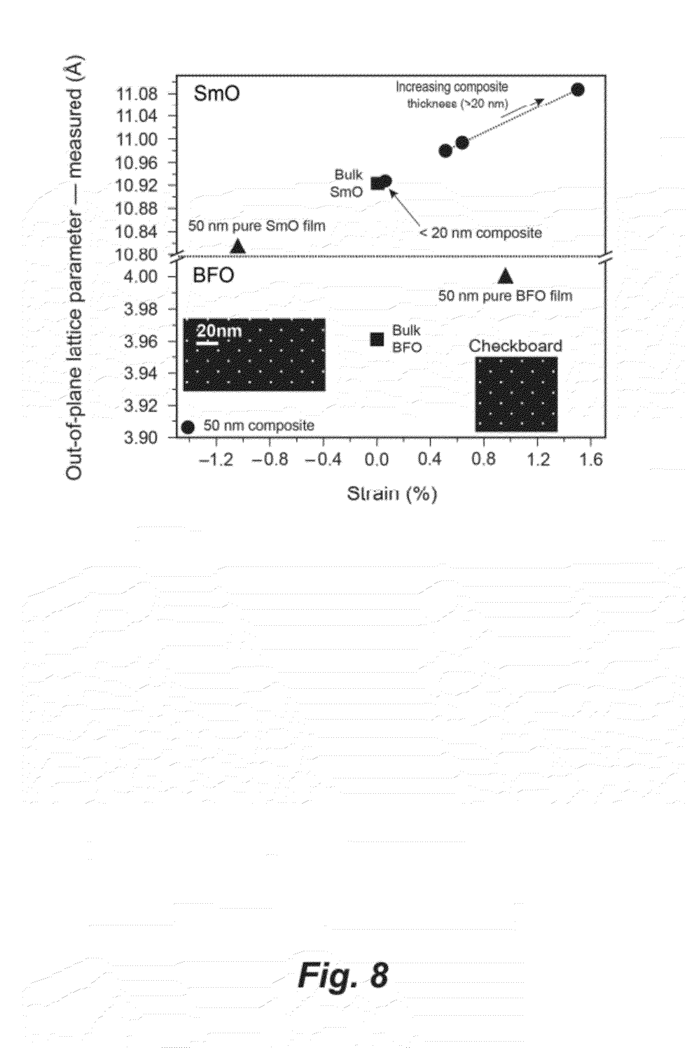

TEM planar micrographs (one rotated 45°, and the other from another region without rotation) of the BFO—SmO film are shown in the inset of FIG. 8. A well ordered structure is observed. The mechanism of spontaneous ordering is presently under study but is believed to result from minimization of elastic strain and interfacial energies, similar to the situation for semiconductor quantum dot nanocrystal growth. However, here there was a three-dimensional situation rather than a two-dimensional one. i.e. initially there is horizontal heteroepitaxy but then vertical heteroepitaxy dominates.

### Example 4

### BFO/NdO VSCN Films

A composite (BiFeO₃)_{0.5}/(Nd₂O₃)_{0.5} target was prepared through standard target preparation procedures. The BFO/NdO nanocomposite films were deposited on SrTiO₃, Nb-doped SrTiO₃, and sapphire substrates by pulsed laser deposition using a XeCl excimer laser (λ=308 nm). A substrate temperature of 670° C. and oxygen pressure of 100 mTorr were used during the deposition. After the deposition, the films were cooled in an oxygen atmosphere of 200 Torr without any further in-situ thermal treatment.

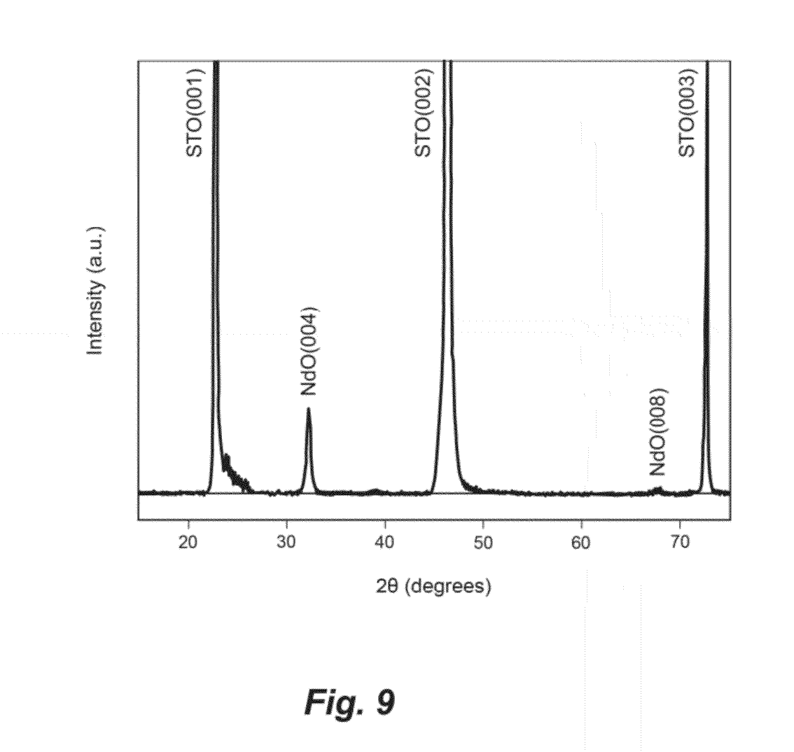

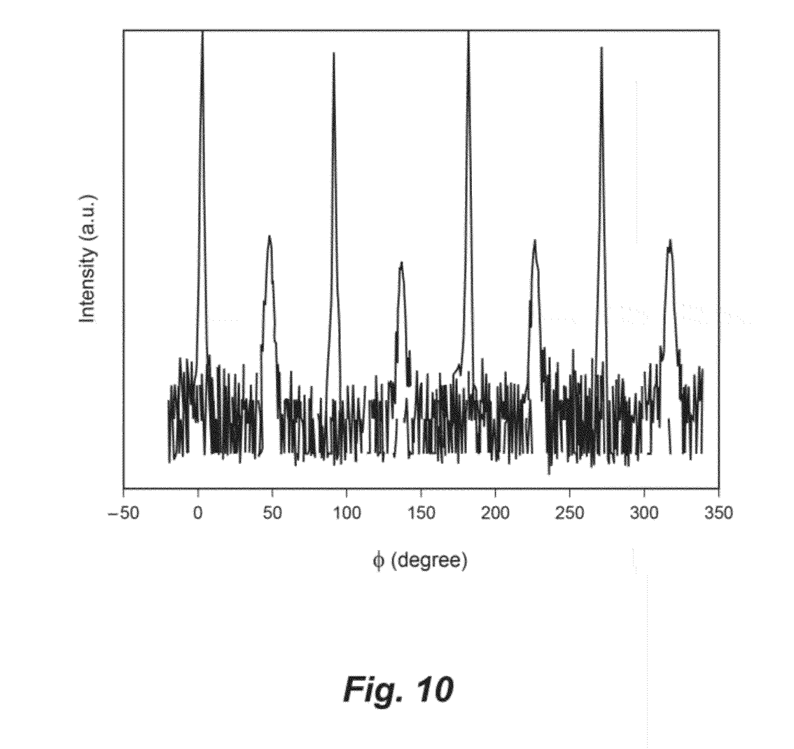

Similar to BFO/SmO, for the BFO/STO nanocomposite on both STO and Nb-doped SrTiO₃ was epitaxy. As shown in FIG. 9, both BFO and NdO were (001) oriented. The in-plane orientation of NdO was rotated by 45 degrees relative to the STO substrate (FIG. 10), which was not surprising considering the lattice constants of NdO (a=1.1077 nm) and STO (a=0.3095 nm).

By comparing the measured lattice constants of both BFO (approximately 0.3095 nm) and NdO (approximately 1.1055 nm), the BFO was in compression and NdO was in a near-relaxed state. In comparison, pure BFO with a thickness of around 100 nm on STO was in a near-relaxed state because its lattice constant was around 0.399 nm. Similar with the BFO/SmO case, the binary oxides strained the perovskites more than the perovskites strained the binary oxides.

### Example 5

### YBCO/BZO VSCN Films

A composite (YBa₂Cu₃O₇)_{0.5}/(BaZrO₃)_{0.5} target was prepared through standard target preparation procedures. The YBCO/BZO nanocomposite films were deposited on STO substrates by pulsed laser deposition using a XeCl excimer laser (2=308 nm). A substrate temperature of 790° C. and oxygen pressure of 200 mTorr were used during the deposition. After the deposition, the films were cooled in an oxygen atmosphere of 200 Torr without any further in-situ thermal treatment.

XRD θ-2θ scan showed that YBCO and BZO were oriented along (001) and (100), respectively. The φ-scans on both YBCO and BZO showed that both YBCO and BZO were oriented in-the-plane as well. For example, FIG. 11 shows the XRD φ-scans of STO (110) and BZO (110) of a YBCO/BZO nanocomposite film on STO substrate. It is clear that the BZO phase is epitaxy with respect to the STO substrate. Similar orientation relationship between the YBCO phase and the STO substrate is observed as well.

The measured lattice constant of the YBCO was around 1.168 nm for the nanocomposite. This value was the same as the lattice parameter of pure YBCO film on STO substrate. On the other hand, the lattice constant of BZO of the nanocomposite was 0.426-0.427 nm, in comparison with values of 0.418 nm (bulk) and 0.419 nm (pure BZO on STO), respectively. The BZO was under tensile strain due to the vertical strain of the YBCO. The STO substrate played a very small role in controlling the strain state of BZO in such a nanocomposite system.

### Example 6

### BTO/SmO VSCN Films

A composite (BaTiO₃)_{0.5}/(SM₂O₃)_{0.5} target was prepared through standard target preparation procedures. The BTO/SmO nanocomposite films were deposited on STO substrates by pulsed laser deposition using a XeCl excimer laser (λ=308 nm). A substrate temperature of 700° C. and an oxygen pressure of 100 mTorr were used during the deposition. After the deposition, the films were cooled in an oxygen atmosphere of 72 Torr without any further in-situ thermal treatment. The cooling rate was 23° C./minute.

XRD θ-2θ scan showed that BTO and SmO were both oriented along (100). Phi scans on both BTO and SmO showed that they were oriented in-the-plane as well.

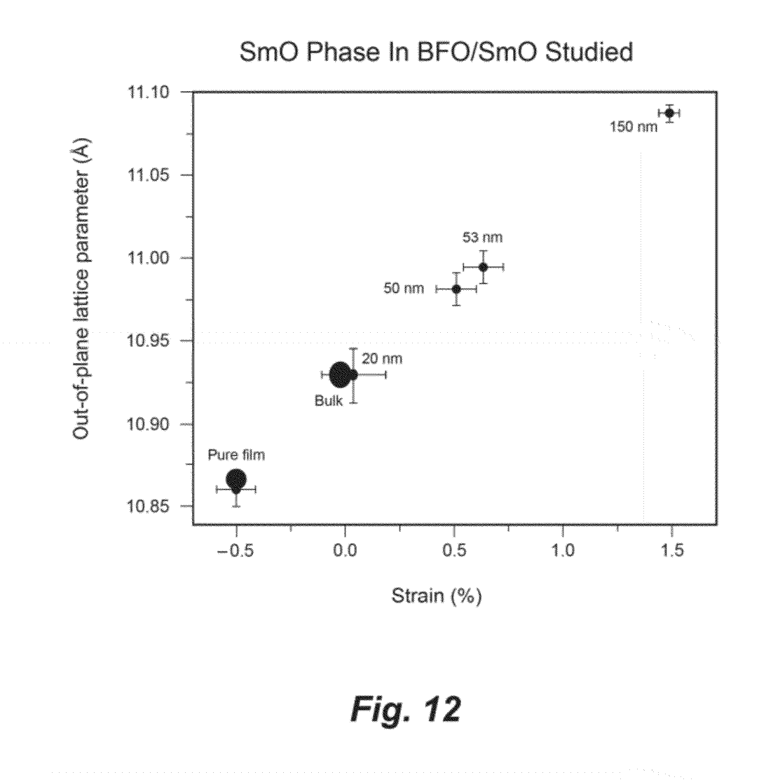

The measured lattice constant of the BTO was 4.013 Å in the pure film, and in the range of 4.033 Å-4.181 Å for the nanocomposite. FIG. 12 shows the shift in x-ray peaks and indicates that the second phases VSCN strain controlling phase causes there to be strong strain control in the BTO in the vertical direction.

### Example 7

### BTO/Rare Earth Oxide VSCN Films

Composite (BaTiO₃)_{0.5}/(RE₂O₃)_{0.5} targets, where RE is a rare earth oxide of Y, Nd, or Sm, were prepared through standard target preparation procedures. The BTO/NdO nanocomposite films were deposited on STO substrates by pulsed laser deposition using a XeCl excimer laser (λ=308 nm). A substrate temperature of 700° C. and oxygen pressure of 100 mTorr were used during the deposition. After the deposition, the films were cooled in an oxygen atmosphere of 100 Torr without any further in-situ thermal treatment. The cooling rate was 23° C./minute.

XRD θ-2θ scan showed that BTO and NdO were oriented along (100). The θ-scans on both BTO and NdO showed that both BTO and NdO were oriented in-the-plane as well.

The measured lattice constant of the BTO was 4.013 Å in the pure film and in the range 4.033-4.181 Å for the nanocomposites. FIG. 12 shows the shift in x-ray peaks and indicates that the second phases VSCN strain controlling phase causes there to be strong strain control in the BTO in the vertical direction.

### Example 8

### BiFeO₃/Fe₂O₃ VSCN films

A 1:1 target of Fe₂O₃ and BFO was prepared by grinding and mixing the relevant oxide powders, both of purity>99.9%. A thin film was grown by PLD on a (100) STO substrate. Before every deposition the substrate was cleaned in ethanol and isopropanol and the target was cleaned by laser ablation. Samples were deposited at conditions known to successfully produce pure BFO films: temperatures ranging from about 600° C. to about 670° C., an oxygen pressure of 100 mtorr, a pulse rate of 2 Hz and a laser energy of ˜240 mJ, but it was found that two phases were absent at 640° C. and 670° C., i.e., neither BFO nor Fe₂O₃ peaks were detectable.

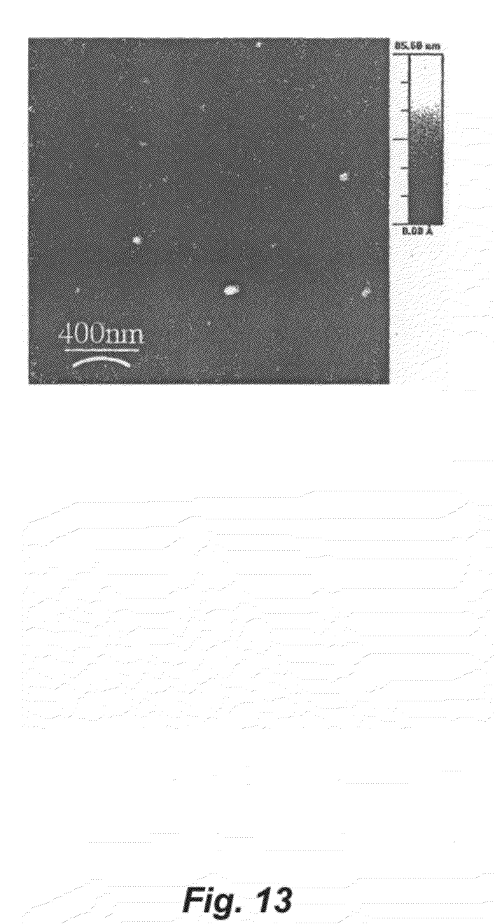

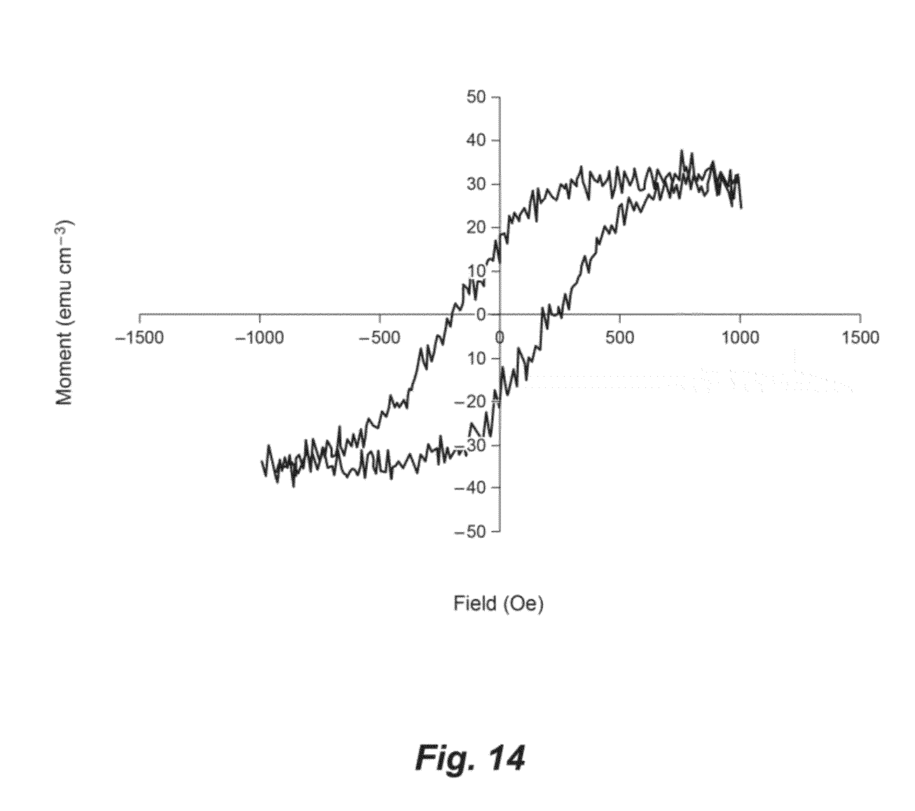

Since Bi is a volatile element it might be expected that higher temperatures would result in a film with little Bi present. The substrate temperature was consequently decreased and at a temperature of 600° C. both BFO and α-Fe₂O₃ peaks were visible. The X-ray diffraction data indicates that the BFO (100) planes and the α-Fe₂O₃ (012) planes lie parallel to the substrate surface. An AFM image showing the 2 phase BFO (background) and Fe₂O₃ grains (triangles) is shown in FIG. 13. The good ferromagnetic properties obtained for this sample are shown in the plot of FIG. 14.

### Example 9

### BaTiO₃/TiO₂ VSCN Films

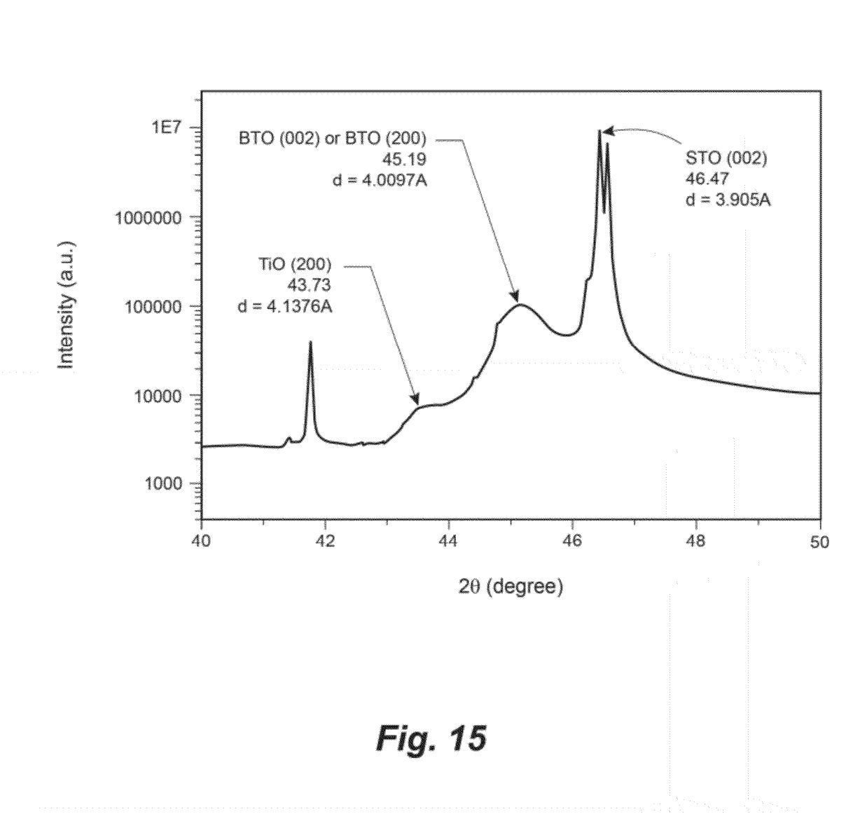

Films were grown using PLD with a KrF laser on 50:50 targets of barium and titanium, made by conventional ceramic sintering. STO substrates were used and the temperature was varied from about 650 to about 800 C under and oxygen pressure of 100 mTorr. The resultant film thicknesses were from about 40 nm to about 400 nm. The XRD of a typically prepared film is shown in FIG. 15 and shows the presence of clean BTO and TiO₂ peaks.

### Example 10

### BaTiO₃/Sm₂O₃ VSCN Films

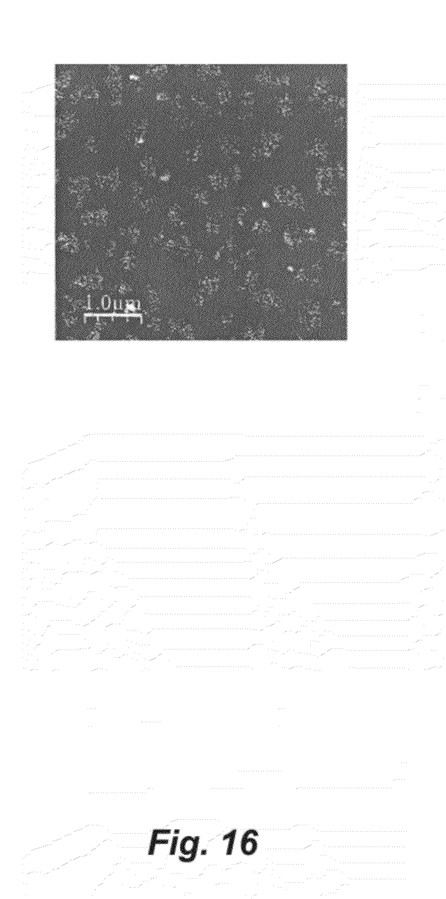

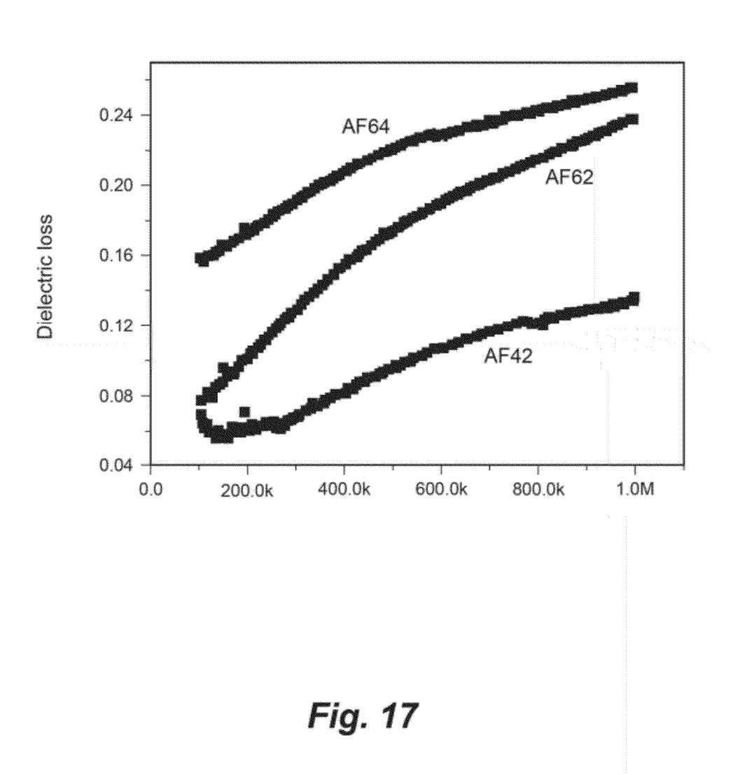

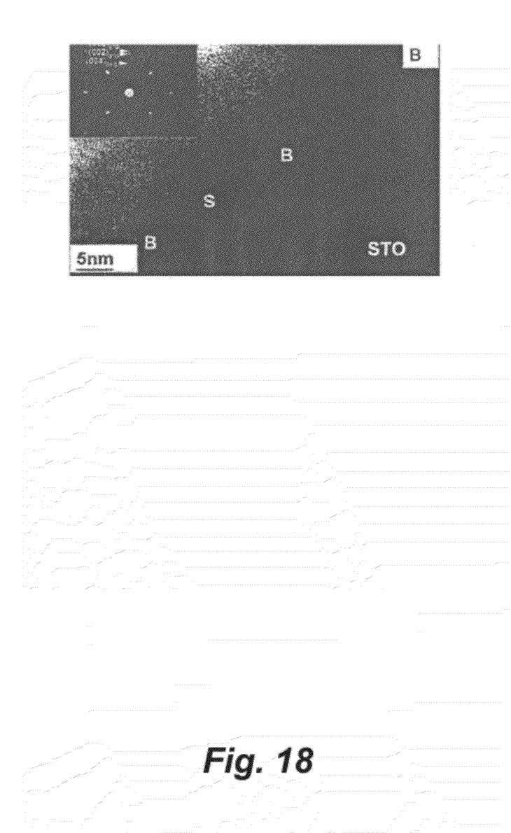

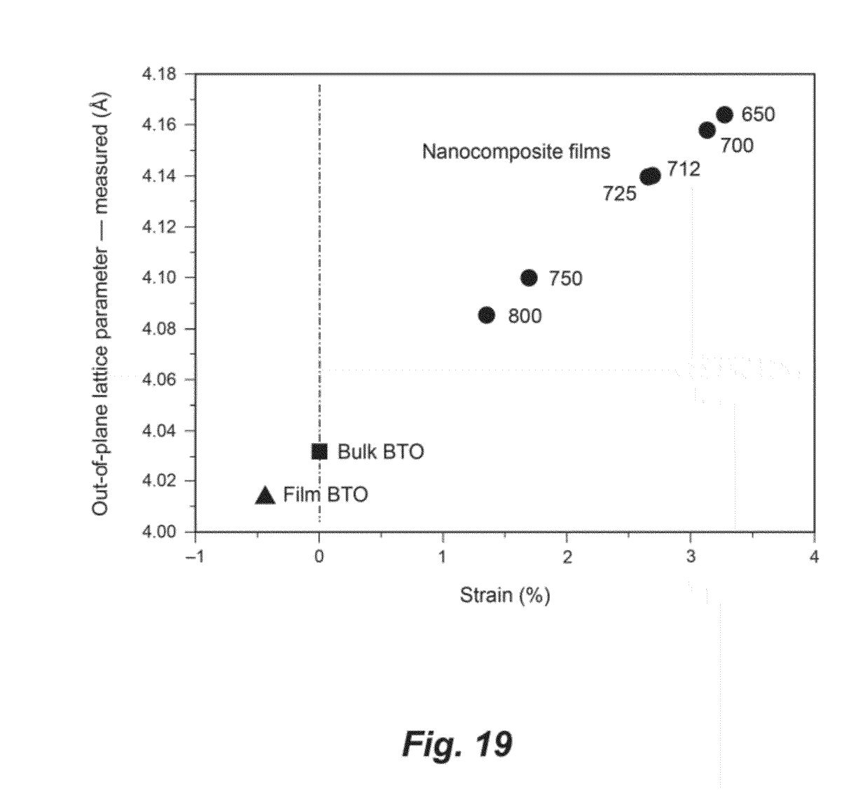

The growth conditions are the same as for BTO/TiO₂ above. An AFM image showing the Sm₂O₃ oval clusters in a background of BTO is shown in FIG. 16. The dielectric properties of the composite show improvement over the single phase material as shown in FIG. 17 where the plot for a pure reference of BTO, is seen together with two different composites grown under different conditions. A TEM cross section image showing the nice nanocomposite structure is shown in FIG. 18. The levels of strain as a function of growth temperature are shown in FIG. 19.

### Example 11

### BaTiO₃/ZrO₂ or Y₂O₃ or Other Rare Earth Oxides VSCN Films

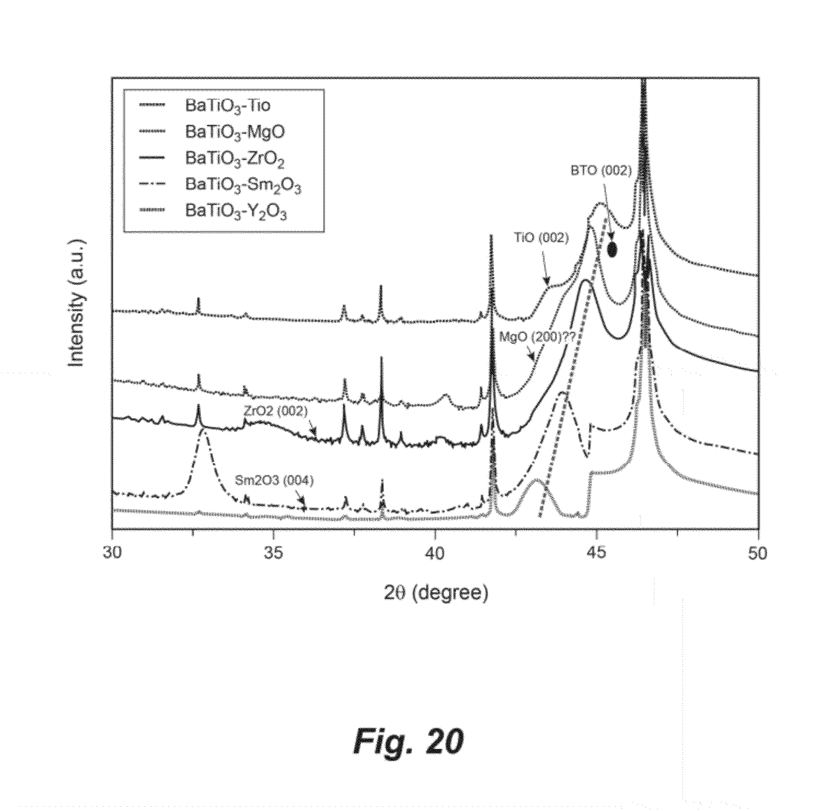

The focus was on examining how the different second phase shifts the strain level in the BTO. The films were all grown as before by PLD but at T=750° C., PO₂=0.15 Torr and frequency=1 Hz. FIG. 20 shows an x-ray diffractogram of different BTO/second phases. It can be seen that the BTO peak is shifted substantially by the presence of the different second phases.

### Example 12

### LaAlO₃/SrTiO₃ VSCN Films

A nanocomposite of LaAlO₃/SrTiO₃ is prepared from a bulk target including lanthanum, aluminum, strontium and titanium, each present in about equal molar amounts. Preparation of the nanocomposite is in the manner used for the preparation of BTO/SmO nanocomposite films on an STO substrate. Interest is in understanding conducting and magnetic effects at the interface of such non-conducting, nonmagnetic oxides. The relevant oxides are otherwise insulating in both bulk and thin-film form. The nanocomposite of LaAlO₃/SrTiO₃ will have a significantly increased interfacial area and may possess an extremely high carrier density with great potential for oxide electronic devices. Furthermore, the interfaces will intersect the film surface allowing probing by more simple, structural methods.

### Example 13

### Cu₂O/ZnO VSCN Films

A target of Cu₂O and ZnO has been made. From XRD, the target was clean and contains the right binary phases. This system is of great interest for stable, cheap inorganic photovoltaics. Preparation of the nanocomposite is in the manner used for the preparation of BTO/SmO nanocomposite films on an STO substrate.

There are many different possibilities for cheaper, non-silicon solar cells. They all rely on the formation of p-n semiconductor heterojunctions, photoexcited generation of carriers, then charge separation to an external circuit to do work driven by the internal field at the semiconductor diode interface. The benefits of all-oxide semiconductor cells are high stability, low cost, high carrier mobility, ease of nanostructuring to give efficient charge separation, and high charge carrier mobility so that charge carrier recombination effects are minimized.

For several reasons, p-type Cu₂O is ideal as a p-type semiconductor to use in solar cells: first, the bandgap of 2.1 eV means that it absorbs in the visible spectrum (i.e. it has dual-functionality as an absorber and hole transporter); secondly, it has good carrier mobility; thirdly, it is non-toxic and inexpensive (in contrast to many common inorganic absorbers and hole-transporters like In₂S₃, CdTe, etc.); fourthly, it is easily synthesized by inexpensive methods.

It is understood that the foregoing detailed description and Examples are merely illustrative and are not to be taken as limitations upon the scope of the invention, which is defined by the appended claims. Various changes and modifications to the disclosed embodiments will be apparent to those skilled in the art. Such changes and modifications, including without limitation those relating to syntheses, formulations, and/or methods of use of the invention, may be made without departing from the spirit and scope thereof.

All publications, patents, and patent applications cited in this specification are herein incorporated by reference as if each individual publication or patent application were specifically and individually indicated to be incorporated by reference.

1. A two-dimensional vertical heteroepitaxial strain controlled composite that is at least 10 nanometers thick and is characterized as having a checkerboard surface, comprising (1) a substrate and (2) a self-assembled layer comprising a material X and a material Y thereon wherein
said material X and said material Y are each immiscible metal containing materials, and
a molar ratio of said material X to said material Y ranges from about 2:3 to 3:2.

2. The two-dimensional vertical heteroepitaxial strain controlled composite of claim 1 wherein material X and said material Y have a difference in room temperature elastic moduli perpendicular to said substrate of at least 50 giganewtons per square meter.

3. The two-dimensional vertical heteroepitaxial strain controlled composite of claim 1 wherein said material X and said material Y are independently selected from M₁O_{Z}, M₁M₂O_{Z}, and M₁M₂M₃O_{Z} wherein M₁, M₂, and M₃ are each independently selected from metals and metalloids.

4. The two-dimensional vertical heteroepitaxial strain controlled composite of claim 1 wherein said material X and said material Y are independently selected from perovskite type materials, rare earth oxide type materials, hexagonal structured metal oxide type materials, fluorite structured metal oxide type materials, rock salt structured metal oxide type materials, pyrochlore structured metal oxide type materials, spinel structured metal oxide type materials, a single metal element, and binary non-oxide compounds.

5. The two-dimensional vertical heteroepitaxial strain controlled composite of claim 1 wherein said molar ratio of said material X to said material Y is around 1:1.

6. The two-dimensional vertical heteroepitaxial strain controlled film structure of claim 5 wherein said material X and said material Y are (i) La_{0.7}Sr_{0.3}MnO₃ and ZnO, (ii) BiFeO₃ and Sm₂O₃, (iii) BiFeO₃ and Nd₂O₃, (iv) YBa₂Cu₃O₇ and BaZrO₃, (v) BaTiO₃ and Sm₂O₃, (vi) BaTiO₃ and Nd₂O₃, or (vii) BaTiO₃ and NiFe₂O₄.

7. A two-dimensional vertical heteroepitaxial strain controlled composite that is at least 10 nanometers thick and is characterized as having an interspersed columnar structure, comprising (1) a substrate and (2) a layer comprising a material X and a material Y thereon wherein
said material X and said material Y are immiscible metal containing materials, and
a molar ratio of said material X to said material Y ranges from about 1:6 to about 6:1, with the proviso that said material X and said material Y are not (i) barium titanate and cobalt ferrite, or (ii) bismuth ferrite and cobalt ferrite.

8. The two-dimensional vertical heteroepitaxial strain controlled composite of claim 7 wherein material X and said material Y have a difference in room temperature elastic moduli perpendicular to said substrate of at least 50 giganewtons per square meter.

9. The two-dimensional vertical heteroepitaxial strain controlled composite of claim 7 wherein material X and said material Y have a molar ratio of said material X to said material Y ranging from about 2:3 to about 3:2.

10. The two-dimensional vertical heteroepitaxial strain controlled composite of claim 7 wherein said material X and said material Y are independently selected from M₁O_{Z}, M₁M₂O_{Z}, and M₁M₂M₃O_{Z} wherein M₁, M₂, and M₃ are each independently selected from metals and metalloids.

11. The two-dimensional vertical heteroepitaxial strain controlled composite of claim 7 wherein said material X and said material Y are independently selected from perovskite type materials, rare earth oxide type materials, hexagonal structured metal oxide type materials, fluorite structured metal oxide type materials, rock salt structured metal oxide type materials, pyrochlore structured metal oxide type materials, spinel structured metal oxide type materials, a single metal element, and binary non-oxide compounds.

12. The two-dimensional vertical heteroepitaxial strain controlled composite of claim 7 wherein said molar ratio of said material X to said material Y is around 1:1.

13. The two-dimensional vertical heteroepitaxial strain controlled film structure of claim 10 wherein said material X and said material Y are (i) La_{0.7}Sr_{0.3}MnO₃ and ZnO, (ii) BiFeO₃ and Sm₂O₃, (iii) BiFeO₃ and Nd₂O₃, (iv) YBa₂Cu₃O₇ and BaZrO₃, (v) BaTiO₃ and Sm₂O₃, (vi) BaTiO₃ and Nd₂O₃, or (vii) BaTiO₃ and NiFe₂O₄.

14. The two-dimensional vertical heteroepitaxial strain controlled film structure of claim 13 wherein said material X and said material Y are (i) LaAlO₃ and SrTiO₃, (ii) BiFeO₃ and Fe₂O₃, (iii) BaTiO₃ and Y₂O₃, (iv) BaTiO₃ and ZrO₂, (v) BaTiO₃ and TiO₂, or (vi) Cu₂O and ZnO.

15. A two-dimensional vertical heteroepitaxial strain controlled composite that is at least 10 nanometers thick and is characterized as having an interspersed columnar structure, comprising: (1) a substrate and (2) a layer comprising material X and a material Y thereon wherein
said material X and said material Y are immiscible metal containing materials,
a molar ratio of said material X to said material Y ranges from about 1:6 to 6:1, and
said material X and said material Y are independently selected from perovskite type materials, rare earth oxide type materials, hexagonal structured metal oxide type materials, fluorite structured metal oxide type materials, rock salt structured metal oxide type materials, pyrochlore structured metal oxide type materials, spinel structured metal oxide type materials, a single metal element, and binary non-oxide compounds.

16. The two-dimensional vertical heteroepitaxial strain controlled composite of claim 15 wherein material X and said material Y have a difference in room temperature elastic moduli perpendicular to said substrate of at least 50 giganewtons per square meter.

17. The two-dimensional vertical heteroepitaxial strain controlled composite of claim 15 wherein material X and said material Y have a molar ratio of said material X to said material Y ranging from about 2:3 to about 3:2.

18. The two-dimensional vertical heteroepitaxial strain controlled composite of claim 15 wherein said molar ratio of said material X to said material Y is around 1:1.

19. The two-dimensional vertical heteroepitaxial strain controlled film structure of claim 15 wherein said material X and said material Y are (i) La_{0.7}Sr_{0.3}MnO₃ and ZnO, (ii) BiFeO₃ and Sm₂O₃, (iii) BiFeO₃ and Nd₂O₃, (iv) YBa₂Cu₃O₇ and BaZrO₃, (v) BaTiO₃ and Sm₂O₃, (vi) BaTiO₃ and Nd₂O₃, or (vii) BaTiO₃ and NiFe₂O₄.

20. The two-dimensional vertical heteroepitaxial strain controlled film structure of claim 15 wherein said material X and said material Y are (i) LaAlO₃ and SrTiO₃, (ii) BiFeO₃ and Fe₂O₃, (iii) BaTiO₃ and Y₂O₃, (iv) BaTiO₃ and ZrO₂, (v) BaTiO₃ and TiO₂, or (vi) Cu₂O and ZnO.
